(19) United States
(12) Patent Application Publication
(10) Pub. No.: US 2023/0082285 A1
(43) Pub. Date: Mar. 16, 2023

(54) FLOATING HYDROELECTRIC POWERPLANT

(71) Applicant: Eiric Skaaren, Houston, TX (US)

(72) Inventor: Eiric Skaaren, Houston, TX (US)

(73) Assignee: Hydroelectric Corporation, Spring, TX (US)

(21) Appl. No.: 17/942,730

(22) Filed: Sep. 12, 2022

(30) Foreign Application Priority Data
Sep. 13, 2021 (NO) 20211095

(51) Int. Cl. H02K 7/18; F03B 3/02

(52) U.S. Cl. CPC H02K 7/1823; F03B 3/02; F05B 2240/95; F05B 2240/93

(57) ABSTRACT

A system that produces electricity offshore through a floating installation, including minimum of; one power production water turbine, one startup generator, a loop system, one air compressor, one high voltage subsea cable, and one control center; whereas the startup generator produces power for about 5-10 minutes before the loop system kicks in, an onshore control center makes it possible for the plant to be operated unmanned, where the surplus electricity generated through the water turbines are transported to the onshore electricity grid or another offshore structure, through a high voltage subsea cable.

### BACKGROUND

### 1. Field of the Invention

The present invention relates generally to electricity generating systems, and more specifically, to an offshore powerplant that utilizes air pressure below the sea surface to lower density of water and force water to drop through a turbine to create energy to transfer to an onshore electricity grid for use.

### 2. Description of Related Art

Offshore power systems are well known in the art and are effective means to generate electricity via turbine movement created by waves or the like. For example, conventional offshore power plants utilize a turbine, in which water rotates blades to convert kinetic energy into potential energy via a generator, which can then be utilized by an onshore electrical grid. However, the current systems are expensive to operate and maintain, and pose significant environmental risks to the surrounding water and marine life.

Although great strides have been made in offshore power generating systems, there is always room for improvement. The current system and method is directed to an offshore power generating system in which air is injected into water, forcing the water to rise, wherein the water can then flow through a water pipe and through a turbine based on gravitational force, thereby creating greater output with minimal energy input. By utilizing the pressure below the sea surface, feasibility studies show that it is possible to reduce the pumping costs by 50%, which is significant. Further, studies have shown that this system is much safer for fish and other marine life than the current methods of offshore power generating. The system also eliminates the risk of large, toxic leaks or spills into the ocean that current offshore power generating systems currently pose.

The invention relates to an efficient way to lift seawater to a height, with the sole intention to produce electricity through standard water turbines while eliminating any significant harm to the surrounding environment. The system can also operate during droughts and times of reduced rain due to the system utilizing depth-related water pressure in order to generate power.

To be able to do so, the power plants will utilize pressure 50-1200 meters below the sea surface. By introducing compressed air into submerged pipes, the water has no other option than to move upwards. This water will then again be used to operate the water turbines that generate electricity. The further below sea level that the system is implemented, the more energy will be generated based on the correlating increase in water pressure. This allows the location of the system to be more flexible than traditional offshore power generating systems, and can be used anywhere there is significant water depth pressure.

The electricity produced offshore will be transported to the onshore electricity grid through a high voltage subsea cable and operated from a remote-control center onshore, leaving the offshore power plant un-manned. This eliminates the cost of labor associated with manning conventional offshore power generating systems.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is an isometric top view of a power generator apparatus in accordance with a preferred embodiment of the present application;

FIG. 2 is an isometric side view of the apparatus of FIG. 1;

FIG. 3 is an isometric bottom view of the apparatus of FIG. 1;

FIG. 4 is a top view of the apparatus of FIG. 1;

FIG. 5 is an isometric view of a pillar and water output pipe of FIG. 1; FIG. 6 is an isometric view of the water output pipe of FIG. 5;

FIG. 7 is an isometric view interior view of a pillar of FIG. 1;

FIG. 8 is an isometric view of an output jet and air flow pipe of FIG. 1; and

FIG. 9 is a simplified schematic of an offshore power plant system with the apparatus of FIG. 1 in accordance with a preferred embodiment of the present application.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

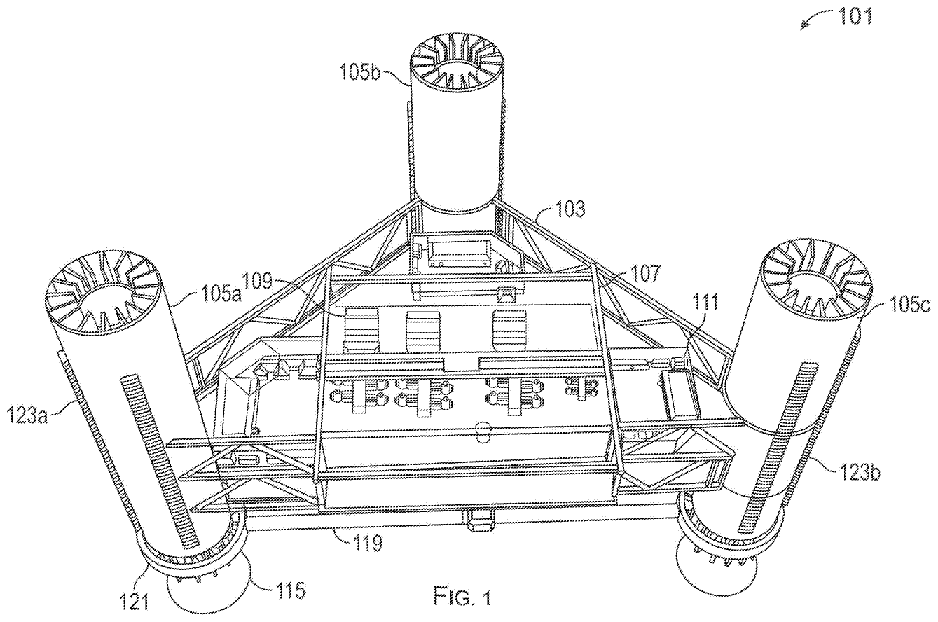

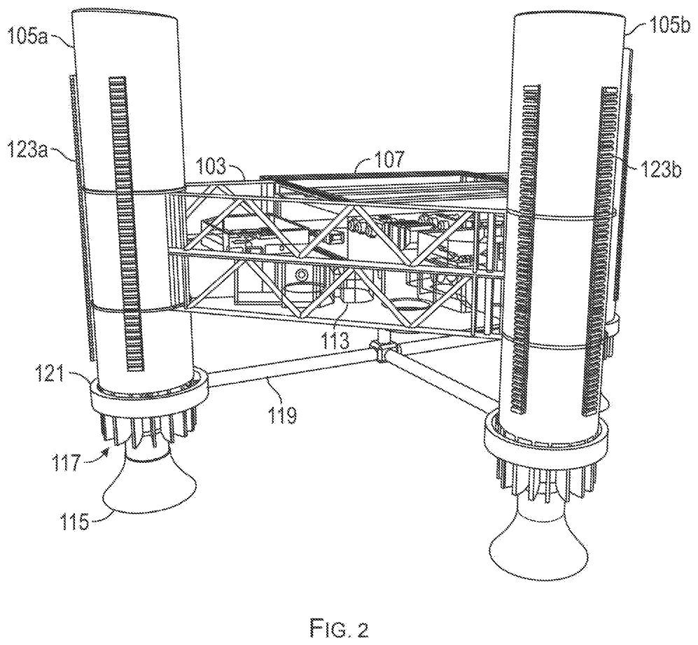

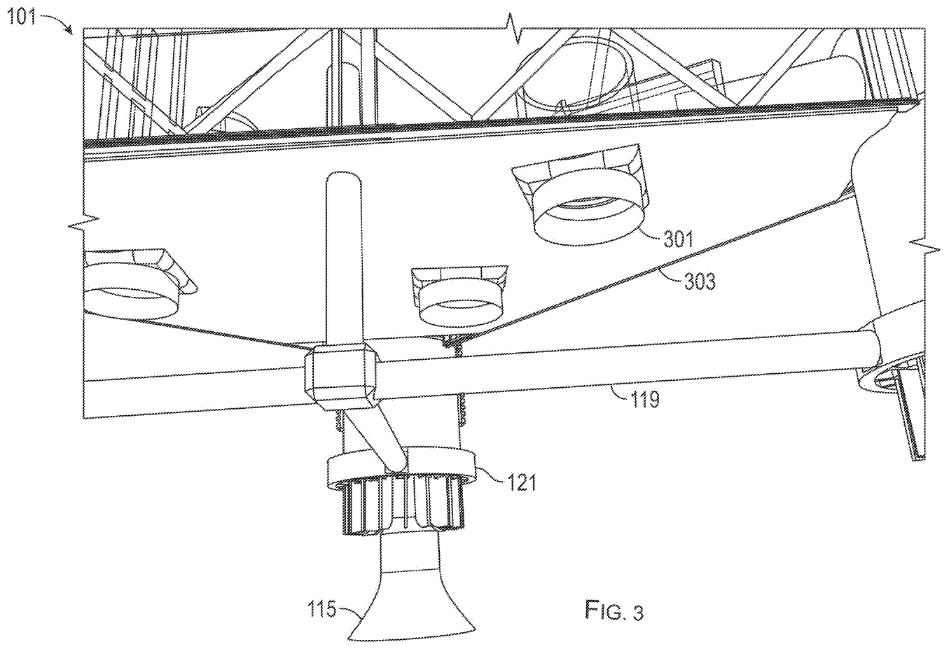

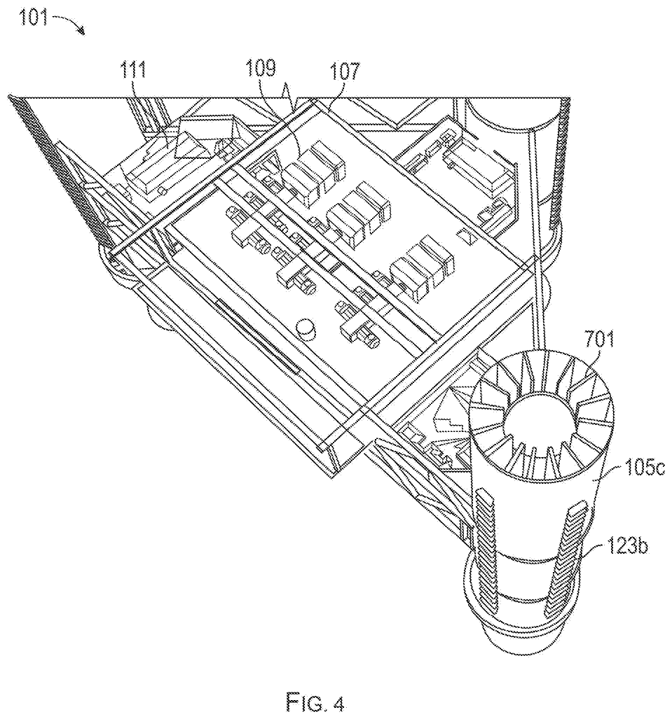

Referring now to the drawings wherein like reference characters identify corresponding or similar elements throughout the several views, FIGS. 1-4 depict various views of a power generator apparatus 101 for use with an offshore electricity producing system in accordance with a preferred embodiment of the present application. It will be appreciated that system 101 overcomes one or more of the above-listed problems commonly associated with conventional power generator systems.

In the contemplated embodiment, apparatus 101 includes a platform 103 mounted on a plurality of pillars 105a-c. The platform 103 holds a compressor building 107 with one or more compressor sets 109 housed therein. Apparatus 101 further includes one or more generators 111, and one or more compressors 113. While the preferred embodiment is for the generators 111 to be gas driven, it is contemplated that other types of generators may also be utilized.

Each of the plurality of pillars 105 includes feet 115 to hold the apparatus on the ground surface, with a portion of the apparatus underwater. Further, each pillar further includes water inlet 117. As shown, air piping 119 connects to the one or more compressor sets 109, and extends to each pillar and engages around the water inlet 117 via an air jet manifold 121 (this feature is further shown in FIG. 7). In some embodiments, each pillar includes a gear system 123, which can provide a means for the platform to be positioned at various heights.

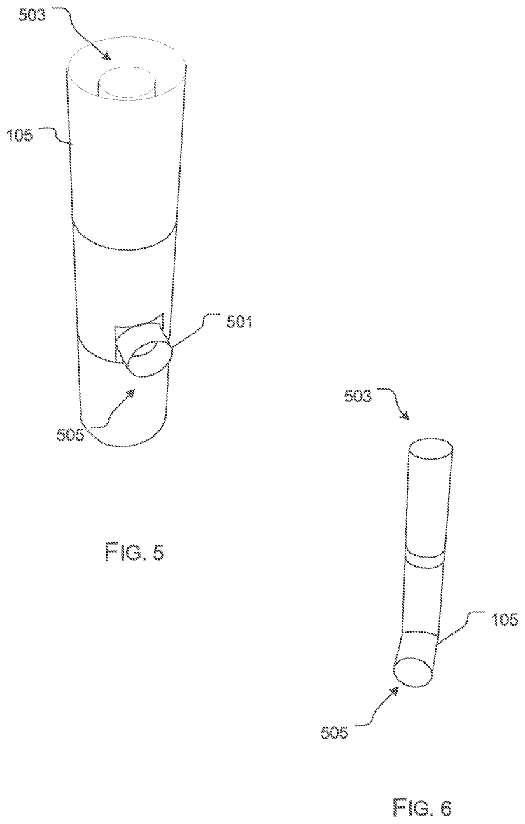

Further, as shown in FIGS. 5 and 6, each pillar 105 houses a water output pipe 501, which extends from a first end 503, to a second end 505. The output pipe 501 is positioned within fins 701 and braces 703a-b, the fins being associated with water inlet, as shown in FIG. 7.

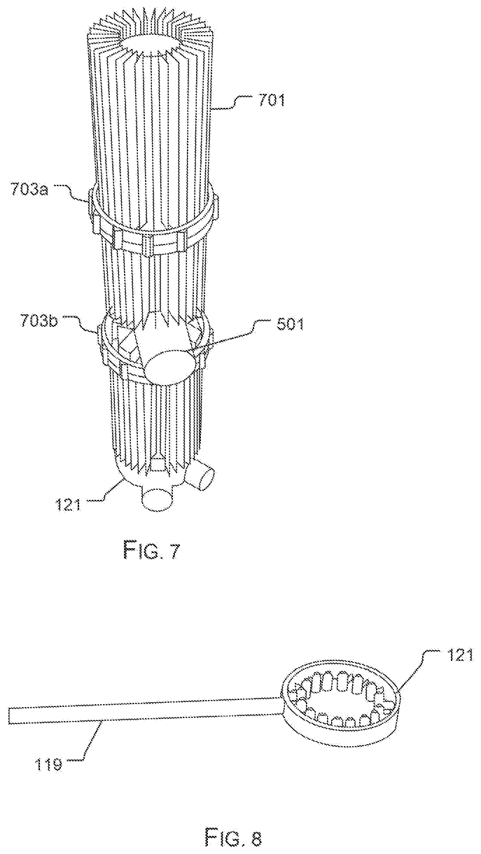

In FIG. 8, an isometric view of an output jet and air flow pipe of FIG. 1 is shown for clarity.

During use, air is injected through piping 119 and into pillars 105, wherein the air mixes with water to lower the density of water. The pillars are positioned wherein a portion of the pillars are underwater, therefore, as the density of water decreases, the water rises above the output pipe 501 in the pillar, and enters from the second end 505, flows through the output pipe and through the first end, and therefore into the one or more turbines 113 to generate electricity via the one or more generators 111.

Apparatus 101 further includes water outlet pipes 301, which in the preferred embodiment are positioned on a base 303 of the platform, wherein the water exits the turbines.

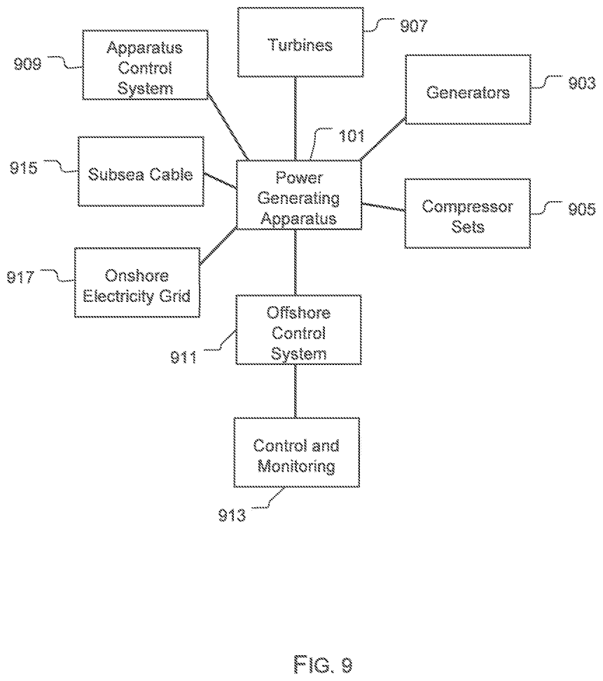

In FIG. 9, a simplified schematic depicts the features of an offshore electricity producing system 901 in accordance with a preferred embodiment of the present application. System 901 includes the apparatus 101, having one or more generators 903, one or more compressor sets 905, and one or more turbines 907, wherein each are controlled via a control system 909. In the preferred embodiment, an offshore control system 911 is implemented for offshore control, wherein the control system 911 provides a means to send commands, and monitor 913 the activities and function of the apparatus. System 901 further includes one or more subsea cables 915 for the transfer of electricity of an onshore electricity grid 917.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. An offshore electricity producing system, comprising;
a power generator apparatus, where the power generator apparatus having;
a floating platform, housing one or more power generation turbines;
one or more startup generators; and
one or more air compressor sets;
one or more pillars, each of the one or more pillars having;
one or more water channels extending into the pillar;
a turbine inlet pipe housed within an interior of the pillar;
an air pipe system connected to the one or more compressor sets and having an output jet positioned around the one or more water channels extending into the pillar;
a water output pipe connected to each of the one or more pillars and configured to push water to one or more turbines;
an offshore control system connected to the power generator apparatus and configured to receive user commands;
wherein air is injected into each of the one or more pillars to lower density of water within the pillar to push a water and air mixture upwards and through the water output pipe and to the one or more turbines to generate energy; and
wherein generated energy is transported to an onshore electricity grid, or to an offshore structure in need of electricity power.

2. The system of claim 1, wherein the power generator apparatus is operated by an offshore control system, allowing the power generator apparatus to be unmanned.

3. The system of claim 1, allowing for a loop system, meaning that the power generator apparatus will utilize its own produced electricity to operate the air compressor pump, after getting the system started by one or more startup generators.

4. The system of claim 1, wherein one or more turbines are Francis turbines.

5. The system of claim 1, that comprises of one or more pillars.

6. The system of claim 1, wherein each of the pillars comprises:
a non foot secured bottom fixed solution, but a floating solution.

7. The system of claim 1, wherein the water output pipe has an end that extends through a thickness of the pillar, and a second end that extends upwards through the pillar, wherein water enters the second end and flows through the first end through the one or more turbines.

8. The system of claim 1, further comprising:
a water outlet pipe positioned through a base of the platform and connecting to each of the one or more turbines.

9. The system of claim 1, wherein one or more startup generators are gas or diesel driven generators, with an option to be fully electric, where one or more startup generators are driven by renewable power sources.
